(19) United States
(12) Patent Application Publication
(10) Pub. No.: US 2020/0211408 A1
(43) Pub. Date: Jul. 2, 2020

(54) QUESTION AND ANSWER DATA OBJECT GENERATION FROM COMMUNICATION SESSION DATA

(71) Applicant: Microsoft Technology Licensing, LLC, Redmond, WA (US)

(72) Inventors: Jason Thomas FAULKNER, Seattle, WA (US); Eric R. SEXAUER, Redmond, WA (US); Tiphanie LAU, Seattle, WA (US)

(21) Appl. No.: 16/232,912

(22) Filed: Dec. 26, 2018

(51) Int. Cl. G09B 7/02

(52) U.S. Cl. CPC G09B 7/02

(57) ABSTRACT

A computer implemented agent may analyze live or stored communication session data for questions posed in a collaborative meeting environment, such as a communication session. The agent may also analyze the live or stored communication session data for answers provided in the collaborative meeting environment. The agent may be functional to create a data object that includes one or more questions posed and answers provided in the collaborative meeting environment. The data object may be decimated to different types of platforms, such as computer applications and websites, that include content contextually relevant to the questions and answers included in the data object.

### BACKGROUND

Some computing systems provide collaborative environments that facilitate communication between two or more participants. A system providing a collaborative environment can allow participants to exchange live video, live audio, and other forms of data within a communication session. A collaborative environment can take on any suitable communication session format including but not limited to private chat sessions, multi-user editing sessions, group meetings, broadcasts, etc.

Recording a communication session may be as important as conducting the communication session. Members of an organization may access past communication session data to recall details of a particular session or to catch up with others if they missed a session. For example, individuals may access communication session data to check the consistency of statements and descriptions, revisit the portions of a session which were missed or not understood, review for questions and answers, reexamine past positions in light of new information and to obtain supportive evidence.

Extracting valuable information from live or stored communication session data is challenging using conventional technical techniques and systems. For example, communication session data is generally manually parsed to extract questions and answers provided by individuals participating in communication sessions. The process of extracting and documenting questions and answers associated with the communication session data consumes a tremendous amount of computer and personnel resources. For example, searching the communication session data for questions and answers increases processor use associated with client computers and servers hosting the meeting data. Furthermore, at least one individual must allocate their time appropriately to search the communication session data. Furthermore, the lengthy process of extracting and documenting questions and answers included in the communication session data means that interested individuals, such as team members, managers and technical experts, may not be able to consider and respond to the questions and answers in a timely manner

Additionally, questions and answers associated with communication session data have a limited audience. Specifically, the questions and answers are generally consumed only by individuals that participated in the communication session in which the questions and answers were presented. Therefore, the questions and answers may not be considered by interested individuals that were unable to attend the communication session associated with the communication session data.

Therefore, there remains a technical need to provide improved computer implemented techniques for extracting questions and answers associated with communication session data. Furthermore, there remains a technical need to disseminate the questions and answers to individuals that were unable to participate in the communication session that sourced the questions and answers.

### SUMMARY

The technologies described herein address the technical need to provide improved techniques for extracting question and answer data from live or stored communication session data. Specifically, the described implementations provide improved use of computing resources, such as a reduction of processor use, by providing a computer implemented agent that autonomously collects question and answer data from live or stored communication session data. In some implementations, the agent parses the communication session data for the question and answer data and extracts, collects and compiles questions and answers from the data. The collected and compiled questions and answers may be distributed to various client computing devices and applications to be displayed, reviewed and acted upon by users of those computing devices.

In some implementations, a meeting agent may analyze and parse live or stored communication session data for questions posed in a collaborative meeting environment, such as a communication session. The agent may also analyze and parse the live or stored communication session data for answers provided in the collaborative meeting environment. The agent may be functional to create a data object that includes collected and compiled questions posed and answers provided in the collaborative meeting environment.

The data object may be distributed through a computer network to client computing devices and users identified by the agent based on one or more factors or criteria. The data object may be displayed by the computing devices to allow individuals to view and respond to questions and answers associated with the data object. In some implementations, the agent may distribute the data object to individuals that may have knowledge, or a skill set, related to a question and/or answer linked to the data object. Alternatively, or in addition, the agent may distribute the data object to individuals invited to the communication session, but that were unable to attend due to scheduling conflicts. In some implementations, the agent may distribute the data object to individuals that are on the same enterprise team or division as some of the participants that attended the communication session. Furthermore, in some implementations, the agent may distribute the data object to enterprise managers and senior managers that may have interest in interviewing the questions and/or answers to the data object.

The agent may be functional to collect, compile and store data that includes answer data provided by individuals that received the data object, including at least one question, created by the agent. The stored data that includes answers provided by the individuals may be linked to the relevant data object and the communication session data in which the at least one question was posed. Therefore, review of the communication session data and agent generated data objects enables individuals to quickly identify questions and answers provided during the collaborative meeting environment associated with the communication session data.

In some implementations, data objects generated by the agent may be communicated to diverse computer applications. For example, a data object that includes at least a question posed during a collaborative meeting may be delivered to an email application, word processing application, spreadsheet application, calendar application, or the like. Therefore, the agent is able to provide the data object to relevant individuals that may not otherwise make use of a computer application that provides access to a collaborative environment, such as a virtual meeting or chat session.

Furthermore, the data objects generated by the agent may include functionality that allows a user to interface with the data object to answer the at least one question included in the data object. Answers provided through the data object may be collected and stored in a storage that the data object accesses. Furthermore, the agent may include functionality that allows a user to interface with the data object to view one or more answers to the at least one question included in the data object.

The agent may also attach or associate permissions with the data object. The permissions assign access rights to the data object to specific users and groups of users. The permissions control the ability of users to view, change, distribute, etc., the data object.

The techniques disclosed herein can provide a number of technical benefits over existing systems. In addition to reducing processor use of a device and other systems, the techniques disclosed herein can also improve the power efficiency of one or more devices. For instance, by providing an agent that autonomously collects questions and answer data, consumption of power resources can be reduced through reduced processor use of computing devices hosting communication session data. Other technical benefits can also be realized from implementations of the technologies disclosed herein. The techniques disclosed herein also provide a number of other production efficiencies by providing a display of contextually-related information to users at an optimal time, e.g., when they are working with a relevant subject, and providing a display of contextually-related information on an optimal platform, e.g., the application or meeting platform they are engaged with. Such benefit further efficiencies with respect to computing resources.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithm(s), hardware logic, and/or operation(s) as permitted by the context described above and throughout the document.

### BRIEF DESCRIPTION OF THE DRAWING

The detailed description is described with reference to the accompanying figures. In the figures, the left-most digit(s) of a reference number identifies the figure in which the reference number first appears. The same reference numbers in different figures indicate similar or identical items.

FIG. 1 illustrates an example scenario involving a system for generating at least one data object that includes questions and answers culled from communication session data.

FIG. 2 illustrates a graphical user interface (GUI) that may be associated with a computerized application that provides a collaborative environment for users of the computerized application.

FIG. 3 illustrates two data objects created by a meeting agent. The data objects may each include questions and answers that the meeting agent recognized from analysis of a collaborative environment, such as a communication session.

FIG. 4 illustrates two data objects created by the meeting agent and communicated to a chat application via the server and/or one or more meeting agents.

FIG. 5 illustrates two data objects created by the meeting agent and communicated to an email application via the server and/or one or more meeting agents.

FIG. 6 illustrates two data objects created by the meeting agent and communicated to a spreadsheet application via the server and/or one or more meeting agents.

FIG. 7 illustrates two data objects created by the meeting agent and communicated to a word processing application via the server and/or one or more meeting agents.

FIG. 8 is a diagram illustrating aspects of a routine for generating a data object from communication session data. The data object may be communicated to one or more computing devices.

FIG. 9 is a diagram illustrating aspects of a routine for disseminating a data object generated from communication session data. The data object may be disseminated by communicating the data object to one or more computer implemented platforms, such as a computer application or computing device.

FIG. 10 is a computing system diagram showing aspects of an illustrative operating environment for the technologies disclosed herein.

FIG. 11 is a computing architecture diagram showing aspects of the configuration and operation of a computing device that can implement aspects of the technologies disclosed herein.

### DETAILED DESCRIPTION

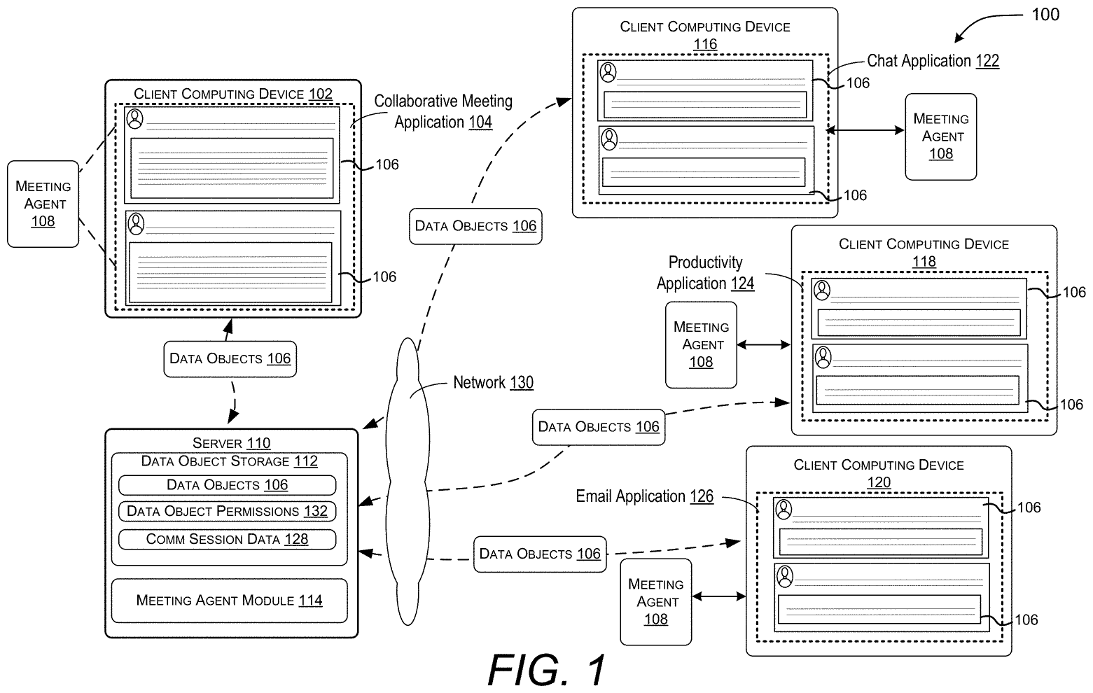

FIG. 1 illustrates an example scenario involving a system 100 for generating at least one data object that includes an inquiry and answers culled and compiled from communication session data. A computing device 102 may include a collaborative meeting application 104. The collaborative meeting application 104 may allow individuals to participate in a communication session, where some of the individuals are co-located and other individuals are located in disparate locations. The communication session may include a virtual meeting in which meeting participants use video, audio and chat to communicate, a chat session, a point to point communication session, and the like.

The collaborative meeting application 104 may display a graphical user interface (GUI) that includes one or more data objects 106. The data objects 106 may be generated by a meeting agent 108. In some implementations, the meeting agent 108 analyzes and parses communication session data generated as individuals participate in a communication session hosted by the collaborative meeting application 104. The communication session data may be sourced from a number of input sources (not illustrated in FIG. 1), including microphones, video cameras, and so forth. Some of the input sources may be co-located, where other input sources may be located in disparate locations.

Each of the data objects 106 may include inquiry and answer data that the meeting agent 108 recognized from parsing the communication session data generated as the individuals participated in the communication session hosted by the collaborative meeting application 104. In some implementations, the meeting agent 108 recognizes inquiries posed during the communication session and answers given to those inquires. The meeting agent 108 may recognize the inquiries and answers using voice, keystroke and/or audio recognition technology. The meeting agent 108 bundles related inquires and answers in each of the data objects 106.

In some implementations, the meeting agent 108 formulates the inquires as questions that are included in each of the data objects. For example, the meeting agent 108 may have intelligence that analyzes inquires made by participants of the communication session and formulates questions from the analysis process. In this disclosure, the term ‘question(s)’ encompasses an actual question posed by a participant of the communication session, an inquiry observed by the meeting agent 108, and a question formulated by the meeting agent 108 from an inquiry or inquiries expressed by one or more participants of the communication session.

The data objects 106 including questions and answer data from the communication session hosted by the collaborative meeting application 104 may be communicated to a server 110. The meeting agent 108 may facilitate the communication of the data object 106 over a network 130 (not illustrated in FIG. 1) or via a point to point communication connection. The server 110 may store the data objects 106 in a data object storage 112. Furthermore, the server 110 may store communication session data 128 that sourced the questions and answers included in the data objects 106. The communication session data 128 may be stored in the data object storage 112, or another storage associated with the server 110 and/or client computing device 102. In some implementations, the server 110 may perform the same functions as described above with reference to the meeting agent 108 and the client computing device 102. For example, the server 110 may generate data objects 106 from communication session data 128 included in storage 112 or from live communication session data associated with a collaborative meeting application 104 or the like.

The data objects 106 may be tied to the communication session data 128 that sourced the questions and answers included in the data objects 106. Common timestamps between the data objects 106 and the communication session data 128 may be used to link the data objects 106 and the communication session data 128. Alternatively, a meeting identifier may be used to link the data objects 106 and the communication session data 128. Other techniques for linking the data objects 106 and the communication session data 128 may also be used. In other implementations, the data objects 106 are standalone objects that are not linked to other data. In implementations, the data objects 106 are linked to a particular client computing device(s) or an application(s) implemented by the particular client computing device.

The network 130 can be a variety of different networks, including the Internet, a local area network (LAN), a wide area network (WAN), a personal area network, a cellular or other phone network, an intranet, other public and/or proprietary networks, combinations thereof, and so forth. It should be noted that the network 130 can be configured to include multiple networks.

The server 110 may further include a meeting agent module 114. The meeting agent module 114 may coordinating the analysis and collection of communication session data performed by the meeting agent 108. As shown in FIG. 1, multiple meeting agents 108 may be implemented by the system 100. The multiple meeting agents 108 may be separate meeting agents controlled by one or more of the devices of the system 100, such as one or more of the computing devices 102, 116, 118, 120 and server 110. Further discussion of the additional meeting agents 108 is provided in the following. In other implementations, the multiple meeting agents 108 may be an extension of a single meeting agent 108, which may be controlled and implemented by the meeting agent module 114. In some implementations, the multiple meeting agents 108 may be associated with a hierarchical meeting agent structure, in which one or more meeting agents 108 within the structure may exert control and/or receive information from other meeting agents 108.

The server 110 may communicate one or more data objects 106 to one or more of the client computing devices 116-120. The client computing devices 116-120 may also be referred to herein as remote computing devices 116-120. The data objects 106 may be displayed by applications 122-126 hosted by respective ones of the client computing devices 116-120. For example, data objects 106 may be displayed in a chat application 122, data objects 106 may be displayed in a productivity application 124 (e.g., word processor application or spreadsheet application), and data objects 106 may be displayed in an email application 126.

A context associated with the one or more data objects 106 may be used in determining which of the one or more of the client computing devices 116-120 are to receive the data objects 106. For example, a context, such as the subject matter, of one or more questions in the one or more data objects 106 may be used in determining which of the client computing devices 116-120 receive the data objects 106. The context associated with the data objects 106 may be determined by analyzing the data of the data objects 106 using one or more of the meeting agents 108 and/or the meeting agent module 114.

Determining the context of the data objects 106 may include analysis of data in the data objects 106 to identify the subject matter covered by the data. Data stored or being used by the client computing devices 116-120 may be analyzed by the system 100 to identify which of the computing devices 116-120 include data contextually relevant to the subject matter covered by the data in the data objects 106. The computing devices 116-120 that include data, such as application data, contextually relevant to the subject matter covered by the data in the data objects 106 may receive one or more of the relevant data objects 106. The referenced data of the computing devices 116-120 may also be referred to as activity data, where the activity data may include user data, data generated by users, data associated with one or more computer applications, and the like. The data objects 106 may be communicated to one or more of the applications 122-126.

Determining that data of the data objects 106 and the data stored or being used by the client computing devices 116-120 are contextually relevant may be based on one or more factor or criterion to conclude a threshold level of relevancy. For example, the data objects 106 may identify users that posed the questions or provided answers included in the data objects 106. One or more of the data objects 106 may be contextually relevant to the activity data of the computing devices 116-120 and therefore meet a threshold level of relevancy when that activity data identifies one or more individuals on the same enterprise team or division as the users that posed questions or provided the answers included in the data objects 106. In another example, the one or more data objects 106 may be contextually relevant to the activity data of the computing devices 116-120 and therefore meet a threshold level of relevancy when that data identifies a user skill set or technical expertise related to a subject matter of the questions or provided answers included in the data objects 106. In yet another example, the one or more data objects 106 may be contextually relevant to the activity data of the computing devices 116-120 and therefore meet a threshold level of relevancy based on a location of a client computing device belonging or assigned to a user of interest. For example, when the location of the computing device is in close proximity the server 110 storing the one or more data objects 106, this may be an indication of contextual relevancy.

In yet another example, the one or more data objects 106 may be contextually relevant to the activity data of the computing devices 116-120 and therefore meet a threshold level of relevancy when that data includes application specific data, such as word processing data, spreadsheet data, communication session data, and the like, including keywords that are found in the questions or provided answers included in the data objects 106. The system 100 may require at least a threshold number of keywords in the activity data of the computing devices 116-120 before determining that the questions or provided answers included in the data objects 106 are contextually relevant, or have satisfied a threshold level of relevancy, to the data of the computing devices 116-120.

In some implementations, the system 100 may weigh the plurality of factors when determining if the data of the data objects 106 and the data of the computing devices 116-120 are contextually relevant and therefore meet a threshold level of relevancy. For example, each of the described plurality factors for determining if the data of data objects 106 and the data of the computing devices 116-120 are contextually relevant may be assigned a relevancy weight value. Therefore, when the system 100, such as the server 110, identifies the occurrence of a plurality of the factors for determining if the data of the data objects 106 and the data of the computing devices 116-120 is present, the weights of each of the factors may be summed and compared against a weight threshold to determine the contextual relevancy.

Users of the client computing devices 116-120 may interact with the displayed data objects 106 to view questions and answers. Furthermore, users may interact with the displayed data objects 106 to respond to questions and answers included in the data objects 106. Meeting agents 108 linked to each of the computing devices 116-120 may update the data objects 106 to include the responses to the questions and answers included in the data objects 106. In some implementations, the meeting agents 108 may spawn additional data objects 106 that include the responses to the questions and answers included in the data objects 106.

The meeting agents 108 linked to each of the client computing devices 116-120 may communicate the updated and/or spawned data objects 106 back to the server 110 for storage in the data object storage 112. Furthermore, the server 110 or the meeting agent 108 may communicate the updated and/or spawned data objects 106 to interested individuals, such as individuals having the skill set or technology background related to the subject matter of the questions and answers of the data objects 106, team members related to individuals that provided the questions and/answers of the data objects 106, participants of a communication session link to the original data objects 106, and so forth.

Data object permissions 132 (also referred to herein as “permissions 132”) may be used to determine which users gain access to, receive, share or may modify data objects 106. Furthermore, the permissions 132 may set forth a persistence period or lifespan of the data objects 106. The persistence period may be defined in minutes, hours or number of days. In some implementations, the permissions 132 may specify the one or more computerized platforms that can access or receive the data objects 106.

The permissions 132 may be stored in the data object storage 112 and linked to the data objects 106. The permissions 132 can control access to specific content, editing capabilities, and overall access to the data objects 106. For example, data objects 106 may be communicated to a plurality of the communication devices 116-120, while permissions 132 linked to the data objects 106 may limit certain users of the communication devices 116-122 to read-only access to the data objects 106. Other users of the communication devices 116-120 may have read and write access to the data objects 106 based on permission criteria linked to the data objects 106.

Data object permissions 132 linked to the data objects 106 may utilize a combination of strict and relaxed policies for accessing and/or editing questions and answers associated with the data objects 106. For example, the permissions 132 may define a threshold where individuals having mid-level manager and higher roles have read and write access to the question and answers associated with the data objects 106. In comparison, in some implementations, the permissions 132 may define that individuals having manager and lower roles have read-only access to the questions and answers associated with data objects 106. Furthermore, in some implementations, the permissions 132 may restrict certain individuals of an enterprise from receiving the data objects 106. For example, permissions 132 associated with the data objects 106 may limit access to the data objects 106 to certain enterprise teams, team members, communication session participants, and the like.

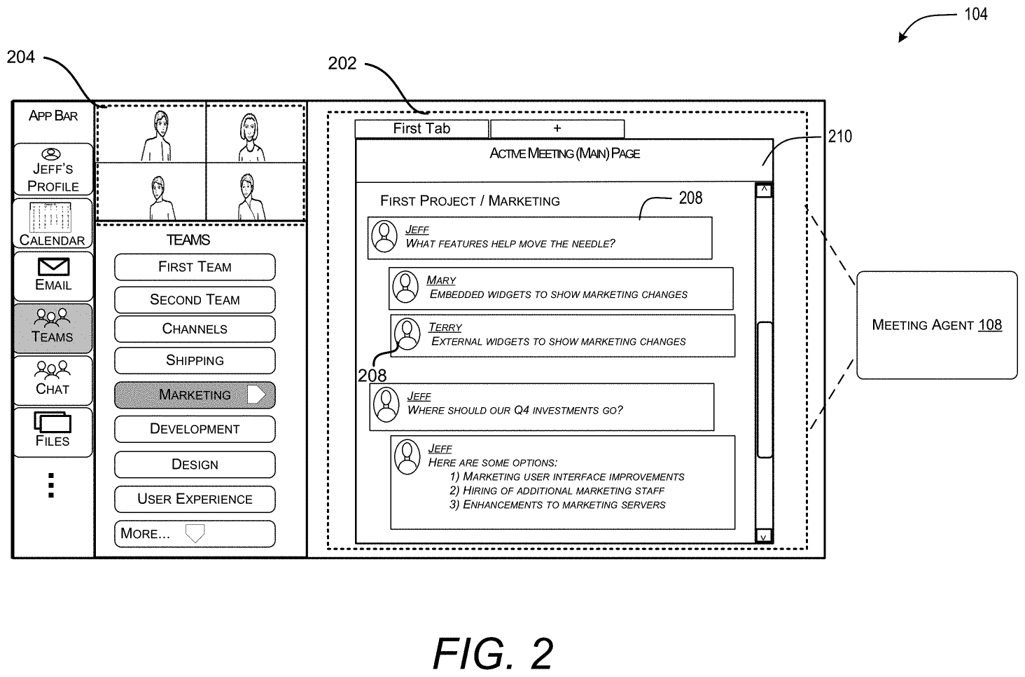

FIG. 2 illustrates a GUI that may be associated with a computerized application that provides a collaborative environment for users of the computerized application. For example, the GUI is provided by the collaborative meeting application 104. The GUI may enable users to participate in a communication session 202. The communication session 202 may include individuals 204 that are co-located and individuals 204 located at disparate locations. The individuals 204 may be participating in the communication session 202 using devices, such as cameras, microphones, and other input devices that collect user inputs. In some implementations, the individuals 204 illustrated in FIG. 2 are virtual representations of the individuals 204, where the virtual representations are generated using input devices associated with one or more computing devices.

Inputs 208 provided by the individuals 204 are represented on a content page 210 of the GUI. The inputs 208 may be generated by a meeting agent 108 overseeing and analyzing inputs provided by the individuals 204. In some implementations, the meeting agent 108 analyzes communication data provided by the individuals 204, to include audio, voice, textual, and other communication data, and formats the communication data for display on the content page 210 of the GUI. In other implementations, the meeting agent 108 analyzes communication data provided by the individuals 204, to include audio, voice, textual, and other communication data, and saves the communication data in a storage that may be accessed by the meeting agent 108.

In some implementations, the displayed or stored communication data, as shown in FIG. 2, may include question and answer data provided by one or more of the individuals 204. The question and answer data are identified and formatted for display on the content page 210 by the meeting agent 108. Alternatively, the question and answer data are stored in a computer storage accessible by at least the meeting agent 108.

As illustrated in FIG. 2, Jeff has posed the question “what features help move the needle?”; Mary and Terry have provided answers to the question. In addition, Jeff has posed another question “where should our Q4 investments go?” and provided a number of different options (i.e., answers) relevant to that question. The meeting agent 108 is functional to analyze the inputs 208 provided by the individuals 204 to recognize when questions have been posed by the individuals 204. Furthermore, the meeting agent 108 is functional to analyze the inputs 208 provided by the individuals 204 to recognize when answers have been provided to the questions posed by the individuals 204.

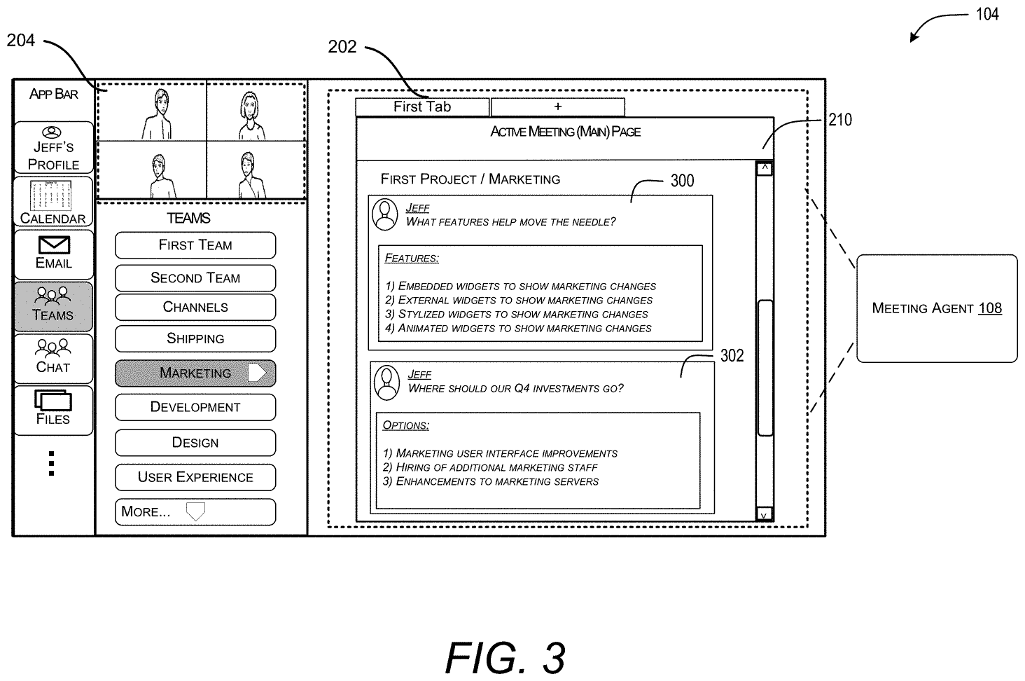

FIG. 3 illustrates two data objects 300 and 302 created by the meeting agent 108. Specifically, the meeting agent 108 analyzed the inputs 208 provided by the individuals 204 in the process of creating the data objects 300 and 302. Analysis of the inputs 208 by the meeting agent 108 revealed that Jeff posed at least two questions during the communication session 202. Furthermore, analysis of the inputs 208 by the meeting agent 108 revealed that a number of answers were provided in response to the questions posed by Jeff. One of the questions posed by Jeff is included in the data object 300. Furthermore, the data object 300 includes several answers in the “features” section, which were recognized by the meeting agent 108. Another of the questions posed by Jeff is included in the data object 302. Similarly, the data object 302 includes several answers in the “options” section, which were recognized by the meeting agent 108. The “Jeff” text may be an identifier indicating who posed the associated question during the communication session. The identifier may be a link that includes an email address for Jeff, office/building location, alias, and the like.

The data objects 300 and 302 may be posted in the content page 210 while the communication session 202 is ongoing. Furthermore, the meeting agent 108 may update one or more of the data objects 300 and 302 as additional answers are provided to the questions shown in the data objects 300 and 302. In some implementations, the meeting agent 108 saves the data objects 300 and 302 persistently in computerized storage, such as the data object storage 112 of the server 110. In addition, the data objects 300 and 302 may be linked to the communication session 202 for retrieval and review at some later time. A common timestamp, session identifier, or other identifier linked to the data objects 300 and 202 and communication session 202 may be used to bind the data objects 300 and 302 to the communication session 202.

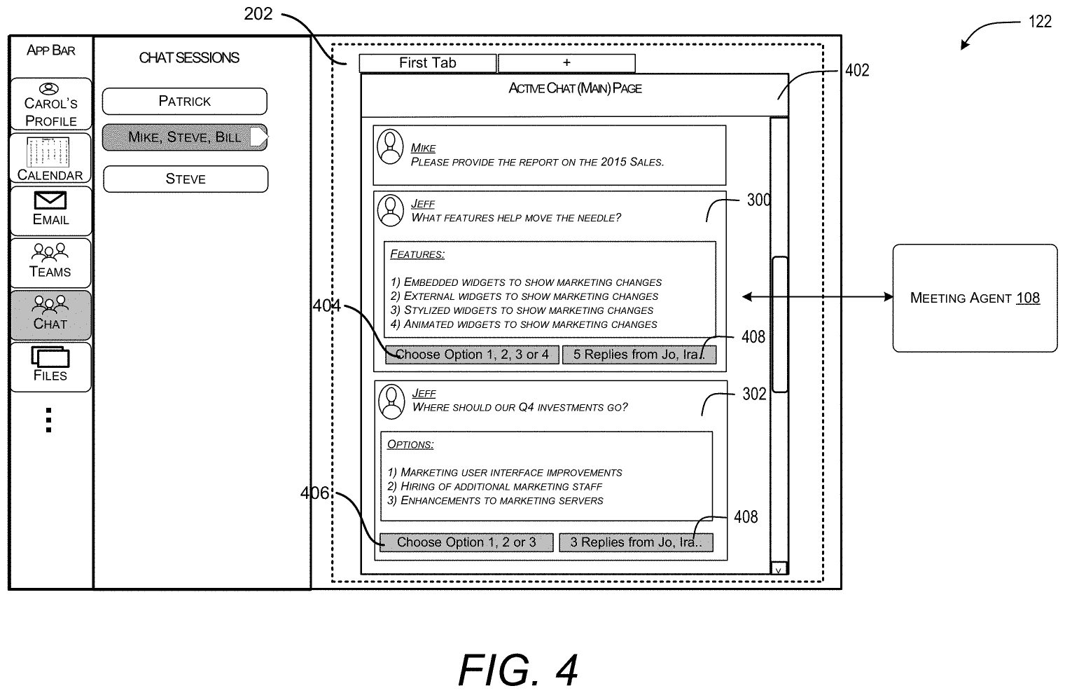

FIG. 4 illustrates the two data objects 300 and 302 created by the meeting agent 108 and communicated to the chat application 122 via the server 110 and/or one or more meeting agents 108. The data objects 300 and 302 are posted to a content page 402 of the chat application 122.

The data objects 300 and 302 have been augmented by the meeting agent 108 to include options fields 404 and 406. The options fields 404 and 406 provide a mechanism that enables a user of the chat application 122 to respond to questions in the data objects 300 and 302.

The meeting agent 108 is functional to detect when a user has interfaced with the options fields 404 and 406. Specifically, the meeting agent 108 may detect when a user has responded to questions associated with the data objects 300 and 302, via the options fields 404 and 406, respectively.

Responses to the questions associated with the data objects 300 and 302 may be stored by the meeting agent 108 in a storage, such as the data object storage 112 and/or the storage integrated with the meeting agent 108. Furthermore, the meeting agent 108 may update the data objects 300 and 302 to show additional responses to the questions associated with the data objects 300 and 302. For example, the meeting agent 108 may continually update answers provided to the question in the data object 300 by listing one or more of those additional answers under the “features” section of the data object 300. Similarly, the meeting agent 108 may continually update answers provided to the question in the data object 302 by listing one or more of those additional answers under the “options” section of the data object 302. Alternatively, or in addition, answers to the questions associated with the data objects 300 and 302 may be stored, such as in the data object storage 112 and/or other storage, and linked to the data object 300 or 302 to ease the future review of stored questions and answers. In other implementations, the meeting agent 108 may spawn additional data objects 106 that include answers to the question and the data object 300 and/or the data object 302. Those additional data objects 106 may be linked to the data object 300 and/or the data object 302 using a common identifier or other data structure linking technique.

Each the data objects 300 and 302 may include a reply field 408. The reply field 408 may list individuals that have responded to a question in the data object 300 or data object 302. A full list of individuals that responded to questions may be accessed via a simple mouse click, or the like, on the appropriate reply field 408.

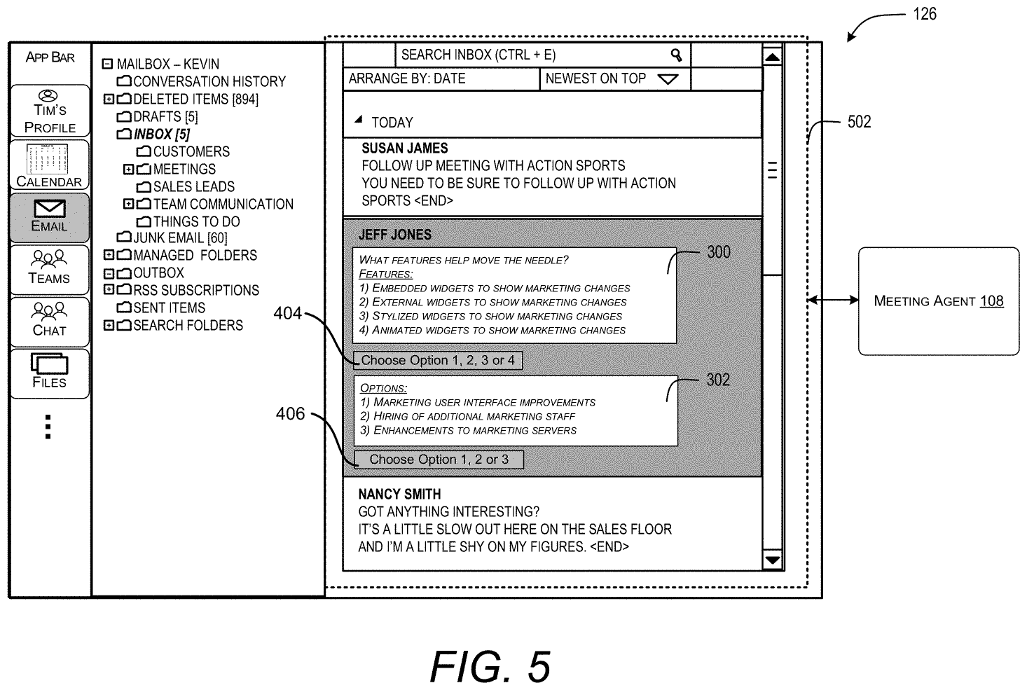

FIG. 5 illustrates the two data objects 300 and 302 created by the meeting agent 108 and communicated to the email application 126 via the server 110 and/or one or more meeting agents 108. The data objects 300 and 302 are included in an email of an inbox 502.

The data objects 300 and 302 have been augmented by the meeting agent 108 to include the options fields 404 and 406. The options fields 404 and 406 provide a mechanism that enables a user of the email application 126 to respond to questions in the data objects 300 and 302.

The meeting agent 108 is functional to detect when a user has interfaced with the options fields 404 and 406. Specifically, the meeting agent 108 may detect when a user has responded to questions associated with the data objects 300 and 302, via the options fields 404 and 406, respectively. In some implementations, the options fields 404 and 406 trigger an email response that is tracked or handled by the meeting agent 108 to ensure answers are stored and linked to the data objects 300 and 302, respectively.

Responses to the questions associated with the data objects 300 and 302 may be stored by the meeting agent 108 in a storage, such as the data object storage 112 and/or the storage integrated with the meeting agent 108.

The meeting agent 108 may update the data objects 300 and 302 to show the responses to the questions associated with the data objects 300 and 302. For example, the meeting agent 108 may continually update answers provided to the question in the data object 300 by listing one or more of those answers under the “features” section of the data object 300. Similarly, the meeting agent 108 may continually update answers provided to the question in the data object 302 by listing one or more of those answers under the “options” section of the data object 302. Alternatively, or in addition, answers to the questions associated with the data objects 300 and 302 may be stored, such as in the data object storage 112 and/or other storage, and linked to the data object 300 or 302 to ease the future review of stored questions and answers. As indicated in the foregoing, the meeting agent 108 may also spawn additional data objects 106 to include answers to questions included in the data objects 300 and 302.

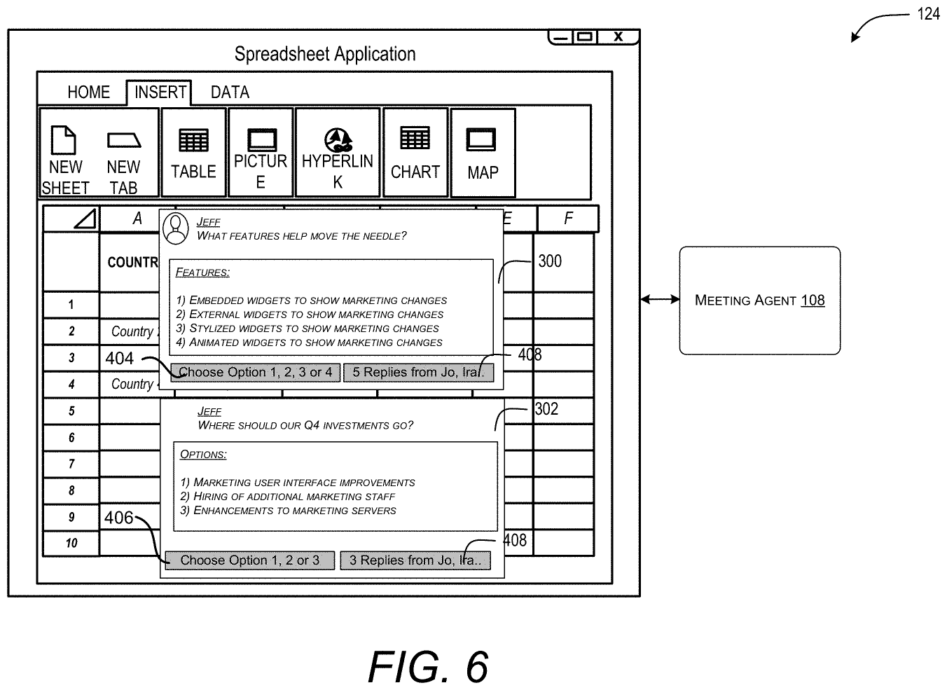

FIG. 6 illustrates the two data objects 300 and 302 created by the meeting agent 108 and communicated to the productivity application 124 via the server 110 and/or one or more meeting agents 108. In the figure, the productivity application 124 is a spreadsheet application, but this is a non-limiting example. The productivity application 124 may also be a word processing application, notes application, or the like. The data objects 300 and 302 are presented as temporary objects that may disappear after a user has interfaced with the data object 300 and/or 302.

The data objects 300 and 302 have been augmented by the meeting agent 108 to include an options fields 404 and 406. The options fields 404 and 406 provide a mechanism that enables a user of the productivity application 124 to respond to questions in the data objects 300 and 302. Furthermore, the data objects 300 and 302 have been augmented to include the fields 408.

The meeting agent 108 is functional to detect when a user has interfaced with the options fields 404 and 406. Specifically, the meeting agent 108 may detect when a user has responded to questions associated with the data objects 300 and 302, via the options fields 404 and 406, respectively.

Responses to the questions associated with the data objects 300 and 302 may be stored by the meeting agent 108 in a storage, such as the data object storage 112 and/or the storage integrated with the meeting agent 108. Furthermore, the meeting agent 108 may update the data objects 300 and 302 to show the responses to the questions associated with the data objects 300 and 302. For example, the meeting agent 108 may continually update answers provided to the question in the data object 300 by listing one or more of those answers under the “features” section of the data object 300. Similarly, the meeting agent 108 may continually update answers provided to the question in the data object 302 by listing one or more of those answers under the “options” section of the data object 302. Alternatively, or in addition, answers to the questions associated with the data objects 300 and 302 may be stored, such as in the data object storage 112 and/or other storage, and linked to the data object 300 or 302 to ease the future review of stored questions and answers.

Each the data objects 300 and 302 may include the reply field 408. The reply field 408 may list individuals that have responded to a question in the data object 300 or data object 302. A full list of individuals that responded to questions may be accessed via a simple mouse click, or the like, on the appropriate reply field 408. Each of the listed individuals may be an identifier indicating who provided the answers. The identifier may be a link that includes an email address for the answerer, office/building location, alias, and the like.

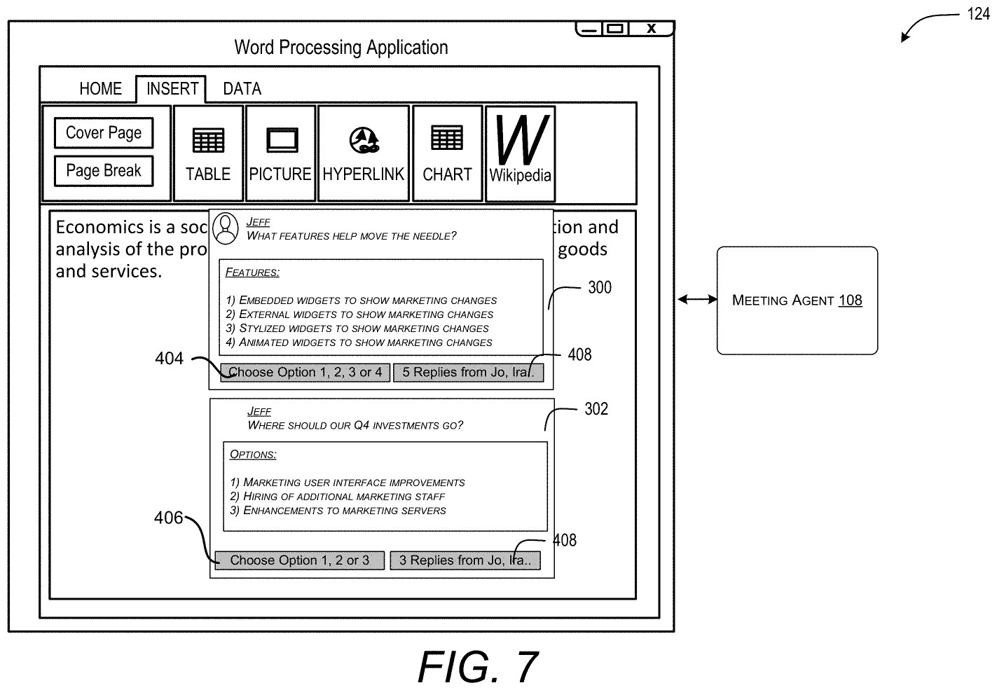

FIG. 7 illustrates the two data objects 300 and 302 created by the meeting agent 108 and communicated to the productivity application 124 via the server 110 and/or one or more meeting agents 108. In the figure, the productivity application 124 is a word processing application, but this is a non-limiting example. The productivity application 124 may also be a slide deck creation application, video editing application, or the like. The data objects 300 and 302 are presented as temporary objects that may disappear after a user has interfaced with the data object 300 and/or 302.

The foregoing describes that data objects 106 may be disseminated to many different platforms, such as different applications 122, 124 and 40/or 126, websites, social media, computing devices, and the like. The meeting agent module 114 in concert with one or more of the meeting agents 108 may consider a context, such as a subject matter, associated with the data objects 106 in determining the platforms to receive the data objects 106. Furthermore, the meeting agent module 114 and the one or more meeting agents 108 may consider a context, such as a subject matter, associated with the applications 122-126 or other platforms in determining which of the data objects 106 are to be communicated to the applications 122-126 or other platforms.

For example, in some implementations, one or more of the meeting agents 108 analyze textual data, audio data, video data, and other data associated with one or more of the applications 122-126 or other platforms to ascertain and establish a context of the data. The analysis performed by the meeting agents 108 may include analyzing documents, chat logs, communication session data, data files, and the like. Furthermore, one or more of the meeting agents 108 may analyze textual data, audio data, video data, and other data associated with one or more of the data objects 106. For example, the meeting agents 108 may analyze questions and/or answers of the data objects 106.

The one or more meeting agents 108 may communicate one or more of the data objects 106 to the applications 122-126 or other platforms when the foregoing analysis shows that a context of one or more of the data objects 106 is the same or substantially the same as the context of data associated with the applications 122-126 or other platforms. The system 100 may include one or more context thresholds that are used by one or more of the meeting agents 108 and/or the meeting agent module 114 to identify the applications 122-126 or other platforms to receive one or more of the data objects 106.

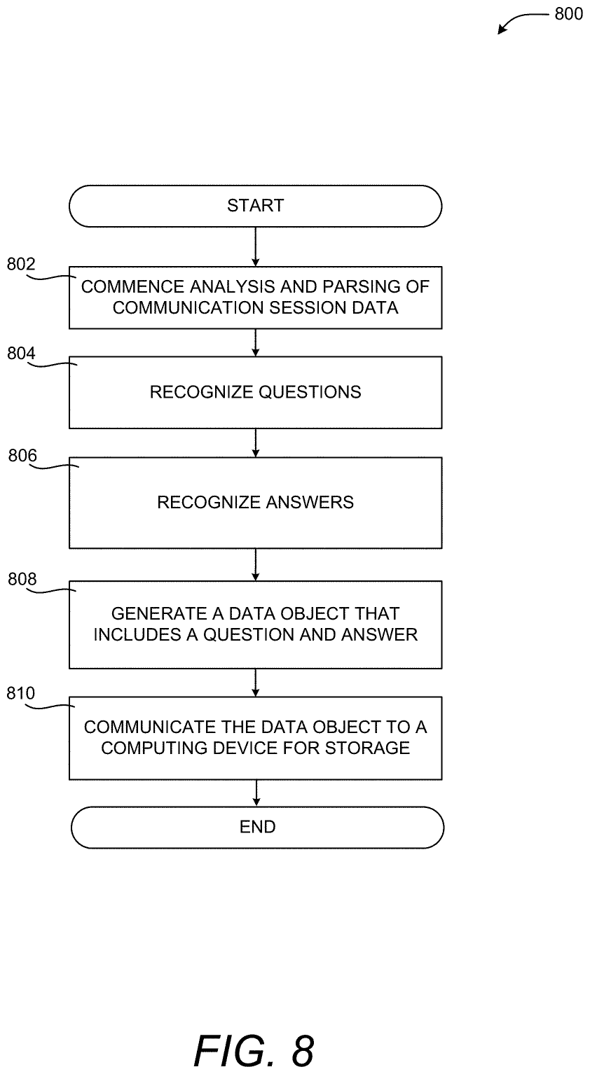

FIG. 8 is a diagram illustrating aspects of a routine 800 for generating a data object from communication session data associated with a communication session. The data object may be communicated to one or more computing devices, such as the computing devices 110 and 116-120. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof

Additionally, the operations illustrated in FIG. 8 and the other FIGURES can be implemented in association with the example computing devices described above. For instance, the various device(s) and/or module(s) described herein can generate, transmit, receive, and/or display data associated with content of a communication session (e.g., live content, broadcasted event, recorded content, etc.) and/or a GUI that includes renderings of one or more participants of remote computing devices, avatars, channels, chat sessions, video streams, images, virtual objects, and/or applications associated with a communication session. The same various device(s) and/or module(s) described herein can generate data objects associated with a communication session and data of the communication session. Those data objects may be linked to a communication session and data of the communication session that were analyzed as part of a process to generate the data objects. The data objects, however, may be utilized independently from the communication session and the data of the communication session. For example, the data objects may be communicated to communication devices, applications executed by communication devices, and the like, for dissemination by and users of those communication devices.

The routine 800 begins at operation 802, where a computer implemented agent commences analysis of communication session data associated with a communication session. The computer implemented agent may be executed by a computing device hosting or displaying the communication session. Alternatively, the computer implemented agent may be executed by a computing device coupled to the computing device hosting or displaying the communication session. For example, a server may provide the computer implemented agent.

At operation 804, the computer implemented agent recognizes one or more questions posed during the communication session. The computer implemented agent recognizes the questions posed during the communication session through analysis of the communication session data. The computer implemented agent may recognize the questions using voice recognition technology or text recognition technology that interfaces with one or more input devices providing content associated with the communication session.

As part of recognizing the one or more questions, the computer implemented agent may also identify individuals that posed the questions. For example, the agent may identify the individuals posing the questions by polling computing devices or input devices for user information to include user identifiers, email addresses, usernames, aliases, public login information, and the like.

At operation 806, the computer implemented agent recognizes one or more answers provided in response to the questions posed during the communication session. The computer implemented agent recognizes the answers provided during the communication session through analysis of the communication session data. The computer implemented agent may recognize the answers using voice recognition technology or text recognition technology that interfaces with one or more input devices providing content associated with the communication session. As part of recognizing the answers, the computer implemented agent may also identify individuals that provided the answers. For example, the agent may identify the individuals providing answers by polling computing devices or input devices for user information to include user identifiers, email addresses, usernames, aliases, public login information, and the like.

At operation 808, the computer implemented agent generates a data object. The data object is platform independent. Therefore, the data object may be rendered and displayed on a plurality of platforms. For example, the data object may be displayed in a computer implemented application, such as a word processor, web browser, spreadsheet, collaborative environment application, and the like. In some implementations, the data object is generated by a server, such as the server 110. The server may parse and analyze communication session data in generating the data object. The server may generate the data object using an agent or using an associated agent module, such as the meeting agent module 114 implemented by a computing device.

The generated data object may include at least one question recognized at operation 804. Furthermore, the generated data object may include at least one answer recognized at operation 806 and related to the question recognized at operation 804. Furthermore, the generated data object may include associated or linked data, such as one or more identifiers, that identifies user information identifying a user that posed the question and a user that provided the answer.

At operation 810, the computer implemented agent communicates the data object to a computing device, such as a computing device that stores data objects that include questions and answers generated from communication session data. The data object may be stored for immediate or later communication to a computer implemented platform based on a context of the question and/or answer in the data. In some configurations, the computer implemented agent communicates the data object to a computing device in response to determining that a context of the question is within a threshold level of relevancy with the context of data or activity data of a client computing device. A threshold level of relevancy may be determined based on one or more factors or criteria. For example, a threshold level of relevancy can include a threshold number of individuals participating in both a communication session associated with the question and user activity of a computerized platform. The threshold level of relevancy can also include a threshold number of keywords that are common between the communication session associated with the question and user activity of a computerized platform. Other technologies, factors, or criteria for determining a threshold level of relevancy can also be utilized.

For example, a context, such as the subject matter, of questions in the data objects may be used in determining which of client computing devices receive the data objects. The context associated with the data objects may be determined by one or more of the meeting agents and/or the meeting agent module. Determining the context of the data objects may include analysis of data in the data objects to identify the subject matter covered by the data. Data stored or being used by the client computing devices may be analyzed by the system to identify which of the computing devices include data contextually relevant to the subject matter covered by the data in the data objects. The computing devices that include data, such as application data, contextually relevant to the subject matter covered by the data in the data objects, may receive one or more of the relevant data objects. The data objects may be communicated to one or more of the applications.

Furthermore, the context may relate to individuals that should receive the questions or review the answers in the data objects. Such individuals may be individuals having the skill set or technology background related to the subject matter of the questions and answers to the data object, team members related to individuals that provided the questions and/or answers to the data objects, managers, executives, and so forth. The routine 800 ends after operation 810.

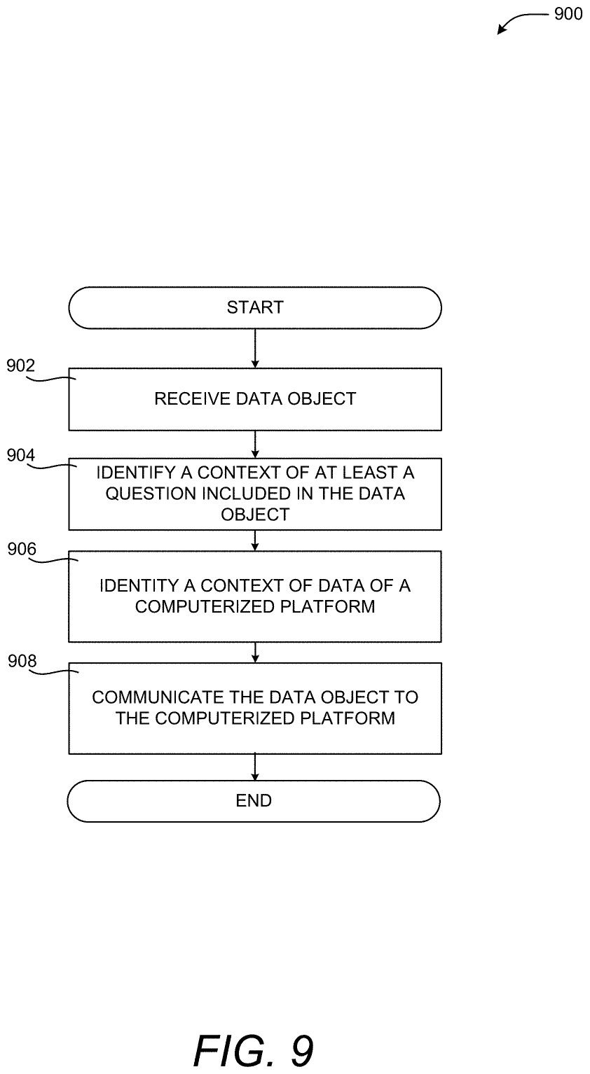

FIG. 9 is a diagram illustrating aspects of a routine 900 for disseminating a data object generated from communication session data associated with a communication session. The data object may be communicated to one more computing devices, such as the computing devices 110 and 116-120. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof

Additionally, the operations illustrated in FIG. 9 and the other FIGURES can be implemented in association with the example computing devices described above. For instance, the various device(s) and/or module(s) described herein can generate, transmit, receive, and/or display data associated with content of a communication session (e.g., live content, broadcasted event, recorded content, etc.) and/or a GUI that includes renderings of one or more participants of remote computing devices, avatars, channels, chat sessions, video streams, images, virtual objects, and/or applications associated with a communication session. The same various device(s) and/or module(s) described herein can generate data objects associated with a communication session and data of the communication session. Those data objects may be linked to a communication session and data of the communication session that were analyzed as part of a process to generate the data objects. The data objects, however, may be utilized independently from the communication session and the data of the communication session. For example, the data objects may be communicated to communication devices, applications executed by communication devices, and the like, for dissemination by and users of those communication devices.

The routine 900 illustrated in FIG. 9 begins at operation 902. At operation 902, a computing device, such as a server device, receives a data object. The data object may include at least one question that was posed during a live or recorded communication session. The question may have been added to the data object based on an analysis of the communication session data associated with the communication session. Furthermore, the data object may include at least one answer to the question that was posed during the communication session.

The data object may include an identifier that represents an individual that posed the question. The identifier may include a name of the individual, an email address of the individual, a building or office location of the individual, and the like. Furthermore, the data object may include an identifier that represents an individual that provided the answer to the question. The identifier of the individual that provided the at least one answer may include a name of the individual, an email address of the individual, a building or office location of the individual, and the like.

Furthermore, the data object may include information that associates the data object with the communication session data. The included information might be in the form of a timestamp of the related communication session, a location of the related communication session, a title of the related communication session, and the like. This included information enables the data object to be linked to the relevant communication session.

At operation 904, a context of the question and/or answer in the data object is identified. For example, the receiving computing device or computerized agent may analyze the data of the data object to determine the subject matter of the data. The analysis performed may include analyzing textual data, audio data, video data, and other data associated with the data object. The analysis may be performed on the question and/or answer in the data object.

At operation 906, a context of data of a computerized platform from data of a plurality of computerized platforms is identified. For example, the receiving computing device or computerized agent may analyze the data of the plurality of computerized platforms to identify the context of data associated with the computerized platform. For example, the computerized platforms may be searched to identify data that is contextually relevant to the identified context. A search of the computerized platforms may include analyzing documents, chat logs, communication session data, data files, and the like.

At operation 908, the data object is communicated to the computerized platform based on the identified contexts.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

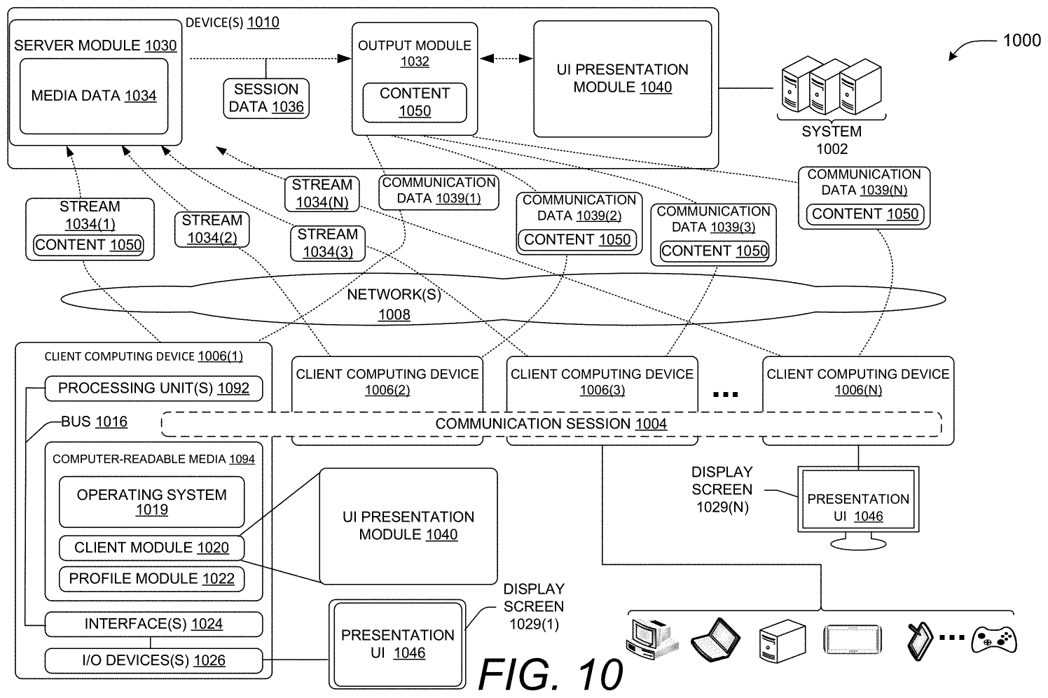

FIG. 10 is a diagram illustrating an example environment 1000 in which a system 1002 can implement the techniques disclosed herein. In some implementations, a system 1002 may function to collect, analyze, and share data defining one or more objects that are displayed to users of a communication session 1004.

As illustrated, the communication session 1004 may be implemented between a number of client computing devices 1006(1) through 1006(N) (where N is a number having a value of two or greater) that are associated with the system 1002 or are part of the system 1002. The client computing devices 1006(1) through 1006(N) enable users, also referred to as individuals, to participate in the communication session 1004.

In this example, the communication session 1004 is hosted, over one or more network(s) 1008, by the system 1002. That is, the system 1002 can provide a service that enables users of the client computing devices 1006(1) through 1006(N) to participate in the communication session 1004 (e.g., via a live viewing and/or a recorded viewing). Consequently, a “participant” to the communication session 1004 can comprise a user and/or a client computing device (e.g., multiple users may be in a room participating in a communication session via the use of a single client computing device), each of which can communicate with other participants. As an alternative, the communication session 1004 can be hosted by one of the client computing devices 1006(1) through 1006(N) utilizing peer-to-peer technologies. The system 1002 can also host chat conversations and other team collaboration functionality (e.g., as part of an application suite).

In some implementations, such chat conversations and other team collaboration functionality are considered external communication sessions distinct from the communication session 1004. A computerized agent to collect participant data in the communication session 1004 may be able to link to such external communication sessions. Therefore, the computerized agent may receive information, such as date, time, session particulars, and the like, that enables connectivity to such external communication sessions. In one example, a chat conversation can be conducted in accordance with the communication session 1004. Additionally, the system 1002 may host the communication session 1004, which includes at least a plurality of participants co-located at a meeting location, such as a meeting room or auditorium, or located in disparate locations.

In examples described herein, client computing devices 1006(1) through 1006(N) participating in the communication session 1004 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 1004 live as activity occurs, or alternatively, via a recording at a later time after the activity occurs. In examples described herein, client computing devices 1006(1) through 1006(N) participating in the communication session 1004 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee to a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 1002 includes device(s) 1010. The device(s) 1010 and/or other components of the system 1002 can include distributed computing resources that communicate with one another and/or with the client computing devices 1006(1) through 1006(N) via the one or more network(s) 1008. In some examples, the system 1002 may be an independent system that is tasked with managing aspects of one or more communication sessions such as communication session 1004. As an example, the system 1002 may be managed by entities such as SLACK, WEBEX, GOTOMEETING, GOOGLE HANGOUTS, etc.

Network(s) 1008 may include, for example, public networks such as the Internet, private networks such as an institutional and/or personal intranet, or some combination of private and public networks. Network(s) 1008 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof Network(s) 1008 may utilize communications protocols, including packet-based and/or datagram-based protocols such as Internet protocol (“IP”), transmission control protocol (“TCP”), user datagram protocol (“UDP”), or other types of protocols. Moreover, network(s) 1008 may also include a number of devices that facilitate network communications and/or form a hardware basis for the networks, such as switches, routers, gateways, access points, firewalls, base stations, repeaters, backbone devices, and the like.

In some examples, network(s) 1008 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 1010 may include one or more computing devices that operate in a cluster or other grouped configuration to share resources, balance load, increase performance, provide fail-over support or redundancy, or for other purposes. For instance, device(s) 1010 may belong to a variety of classes of devices such as traditional server-type devices, desktop computer-type devices, and/or mobile-type devices. Thus, although illustrated as a single type of device or a server-type device, device(s) 1010 may include a diverse variety of device types and are not limited to a particular type of device. Device(s) 1010 may represent, but are not limited to, server computers, desktop computers, web-server computers, personal computers, mobile computers, laptop computers, tablet computers, or any other sort of computing device.

A client computing device (e.g., one of client computing device(s) 1006(1) through 1006(N)) may belong to a variety of classes of devices, which may be the same as, or different from, device(s) 1010, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 1006(1) through 1006(N) of the various classes and device types can represent any type of computing device having one or more data processing unit(s) 1012 operably connected to computer-readable media 1094 such as via a bus 1016, which in some instances can include one or more of a system bus, a data bus, an address bus, a PCI bus, a Mini-PCI bus, and any variety of local, peripheral, and/or independent buses.

Executable instructions stored on computer-readable media 1094 may include, for example, an operating system 1019, a client module 1020, a profile module 1022, and other modules, programs, or applications that are loadable and executable by data processing units(s) 1092.

Client computing device(s) 1006(1) through 1006(N) may also include one or more interface(s) 1024 to enable communications between client computing device(s) 1006(1) through 1006(N) and other networked devices, such as device(s) 1010, over the network(s) 1008. Such network interface(s) 1024 may include one or more network interface controllers (NICs) (not shown in FIG. 10) or other types of transceiver devices to send and receive communications and/or data over a network. Moreover, client computing device(s) 1006(1) through 1006(N) can include input/output (“I/O”) interfaces (devices) 1026 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 10 illustrates that client computing device 1006(1) is in some way connected to a display device (e.g., a display screen 1029(1)), which can display a UI according to the techniques described herein.

In the example environment 1000 of FIG. 10, client computing devices 1006(1) through 1006(N) may use their respective client modules 1020 to connect with one another and/or other external device(s) in order to participate in the communication session 1004, or in order to contribute activity to a collaboration environment. For instance, a first user may utilize a client computing device 1006(1) to communicate with a second user of another client computing device 1006(2). When executing client modules 1020, the users may share data, which may cause the client computing device 1006(1) to connect to the system 1002 and/or the other client computing devices 1006(2) through 1006(N) over the network(s) 1008.

The client computing device(s) 1006(1) through 1006(N) may use their respective profile modules 1022 to generate participant profiles (not shown in FIG. 10) and provide the participant profiles to other client computing devices and/or to the device(s) 1010 of the system 1002. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 10, the device(s) 1010 of the system 1002 include a server module 1030 and an output module 1032. In this example, the server module 1030 is configured to receive, from individual client computing devices such as client computing devices 1006(1) through 1006(N), media streams 1034(1) through 1034(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 1030 is configured to receive a collection of various media streams 1034(1) through 1034(N) during a live viewing of the communication session 1004 (the collection being referred to herein as “media data 1034”). In some scenarios, not all of the client computing devices that participate in the communication session 1004 provide a media stream. For example, a client computing device may only be a consuming, or a “listening”, device such that it only receives content associated with the communication session 1004 but does not provide any content to the communication session 1004.

In various examples, the server module 1030 can select aspects of the media streams 1034 that are to be shared with individual ones of the participating client computing devices 1006(1) through 1006(N). Consequently, the server module 1030 may be configured to generate session data 1036 based on the streams 1034 and/or pass the session data 1036 to the output module 1032. Then, the output module 1032 may communicate communication data 1039 to the client computing devices (e.g., client computing devices 1006(1) through 1006(3) participating in a live viewing of the communication session). The communication data 1039 may include video, audio, and/or other content data, provided by the output module 1032 based on content 1050 associated with the output module 1032 and based on received session data 1036.

As shown, the output module 1032 transmits communication data 1039(1) to client computing device 1006(1), and transmits communication data 1039(2) to client computing device 1006(2), and transmits communication data 1039(3) to client computing device 1006(3), etc. The communication data 1039 transmitted to the client computing devices can be the same or can be different (e.g., positioning of streams of content within a user interface may vary from one device to the next).

In various implementations, the device(s) 1010 and/or the client module 1020 can include UI presentation module 1040. The UI presentation module 1040 may be configured to analyze communication data 1039 that is for delivery to one or more of the client computing devices 1006. Specifically, the UI presentation module 1040, at the device(s) 1010 and/or the client computing device(s) 1006, may analyze communication data 1039 to determine an appropriate manner for displaying video, image, and/or content on the display screen 1029 of an associated client computing device 1006. In some implementations, the UI presentation module 1040 may provide video, image, and/or content to a presentation UI 1046 rendered on the display screen 1029 of the associated client computing device 1006. The presentation UI 1046 may be caused to be rendered on the display screen 1029 by the UI presentation module 1040. The presentation UI 1046 may include the video, image, and/or content analyzed by the UI presentation module 1040.

In some implementations, the presentation UI 1046 may include a plurality of sections or grids that may render or comprise video, image, and/or content for display on the display screen 1029. For example, a first section of the presentation UI 1046 may include a video feed of a presenter or individual, a second section of the presentation UI 1046 may include a video feed of an individual consuming meeting information provided by the presenter or individual. The UI presentation module 1040 may populate the first and second sections of the presentation UI 1046 in a manner that properly imitates an environment experience that the presenter and the individual may be sharing.

In some implementations, the UI presentation module 1040 may enlarge or provide a zoomed view of the individual represented by the video feed in order to highlight a reaction, such as a facial feature, the individual had to the presenter. In some implementations, the presentation UI 1046 may include a video feed of a plurality of participants associated with a meeting, such as a general communication session. In other implementations, the presentation UI 1046 may be associated with a channel, such as a chat channel, enterprise teams channel, or the like. Therefore, the presentation UI 1046 may be associated with an external communication session that is different than the general communication session.

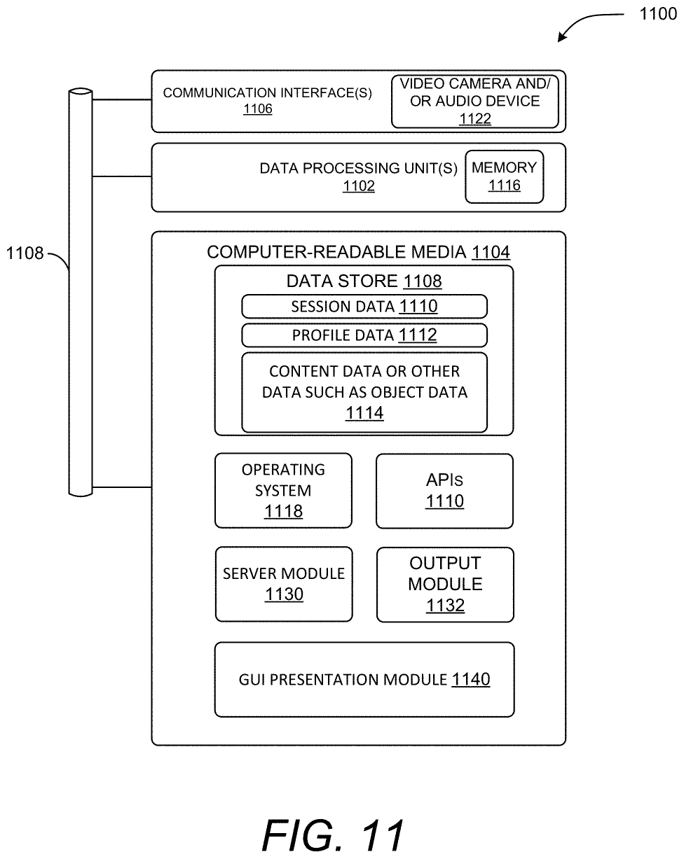

FIG. 11 illustrates a diagram that shows example components of an example device 1100 (also referred to herein as a “computing device”) configured to generate data for some of the user interfaces disclosed herein. The device 1100 may generate data that may include one or more sections that may render or comprise video, images, virtual objects, and/or content for display on the display screen. The device 1100 may represent one of the device(s) described herein. Additionally, or alternatively, the device 1100 may represent one of the client computing devices 1006. Furthermore, the device 1100 may implement any of the modules and agents described herein.

As illustrated, the device 1100 includes one or more data processing unit(s) 1102, computer-readable media 1104, and communication interface(s) 1106. The components of the device 1100 are operatively connected, for example, via a bus 1108, which may include one or more of a system bus, a data bus, an address bus, a PCI bus, a Mini-PCI bus, and any variety of local, peripheral, and/or independent buses.

As utilized herein, data processing unit(s), such as the data processing unit(s) 1102, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 1104 and computer-readable media 1094, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 1106 may represent, for example, network interface controllers (“NICs”) or other types of transceiver devices to send and receive communications over a network (not shown in FIG. 11). Furthermore, the communication interface(s) 1106 may include one or more video cameras and/or audio devices 1122 to enable generation of video feeds and/or still images, and so forth.

In the illustrated example, computer-readable media 1104 includes a data store 1108. In some examples, the data store 1108 includes data storage such as a database, data warehouse, or other type of structured or unstructured data storage. In some examples, the data store 1108 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 1108 may store data for the operations of processes, applications, components, and/or modules stored in computer-readable media 1104 and/or executed by data processing unit(s) 1102 and/or accelerator(s). For instance, in some examples, the data store 1108 may store session data 1110 (e.g., session data 1036), profile data 1112 (e.g., associated with a participant profile), and/or other data. The session data 1110 can include a total number of participants (e.g., users and/or client computing devices) in a communication session, activity that occurs in the communication session, a list of invitees to the communication session, and/or other data related to when and how the communication session is conducted or hosted. The data store 1108 may also include content data 1114 (e.g., object data), such as the content that includes video, audio, or other content for rendering and display on one or more of the display screens 1029.

Alternately, some or all of the above-referenced data can be stored on separate memories 1116 on board one or more data processing unit(s) 1102 such as a memory on board a CPU-type processor, a GPU-type processor, an FPGA-type accelerator, a DSP-type accelerator, and/or another accelerator. In this example, the computer-readable media 1104 also includes an operating system 1118 and application programming interface(s) 1110 (APIs) configured to expose the functionality and the data of the device 1100 to other devices. Additionally, the computer-readable media 1104 includes one or more modules such as the server module 1130, the output module 1132, and the GUI presentation module 1140, although the number of illustrated modules is just an example, and the number may vary higher or lower. That is, functionality described herein in association with the illustrated modules may be performed by a fewer number of modules or a larger number of modules on one device or spread across multiple devices.

### EXAMPLE CLAUSES

The disclosure presented herein encompasses the subject matter set forth in the following clauses.

Clause 1. A computing device, comprising: a processor; a computer-readable storage medium in communication with the processor, the computer-readable storage medium having computer-executable instructions stored thereupon which, when executed by the processor, cause the processor to: receive, at the computing device, a data object that includes a question associated with communication session data linked to a live or recorded communication session; identify, by the computing device, a first context of the question included in the data object; identify, by the computing device, a second context of data of a computerized platform from data of a plurality of computerized platforms; compare the first context and the second context; determine the first context and the second context are related contextually from comparing the first context and the second context; and communicate the data object to the computerized platform.

Clause 2. The computing device according to clause 1, wherein identifying the first context comprises analyzing the question included in the data object to identify a subject matter of the question and identifying the second context comprises analyzing the data of the computerized platform to determine the subject matter of the data of the computerized platform.

Clause 3. The computing device according to at least one of clauses 1-2, wherein determining the first context and the second context are contextually related comprises determining that the subject matter of the question and the subject matter of the data of the computerized platform are related contextually.

Clause 4. The computing device according to at least one of clauses 1-3, wherein the computerized platform is a computer application to display the data object including the question.

Clause 5. The computing device according to clause 4, wherein the computer application is a word processing application, spreadsheet application, web browser application, or collaborative meeting application.

Clause 6. The computing device according to at least one of clauses 1-5, further comprising assigning at least one permission to the data object in advance of communicating the data object to the computerized platform.

Clause 7. The computing device according to clause 6, wherein the at least one permission is used to determine which users gain access to, receive or modify the data object.

Clause 8. The computing device according to at least one of clauses 1-7, further comprising receiving an updated data object derived from the data object communicated to the computerized platform.

Clause 9. The computing device according to clause 8, wherein the updated data object includes data representing an answer to the at least one question.

Clause 10. A method for generating a data object that includes content from a communication session, the method comprising: analyzing, by a computer implemented agent, communication session data to identify at least one question posed and at least one answer to the at least one question posed during communication session associated with the communication session data; generating, by the computer implemented agent, a data object that includes the at least one question and the at least one answer that occurred during the communication session; and communicating the data object to a computing device, the computing device to store the data object for dissemination to at least one computer implemented platform based on a context of the at least one question included in the data object.

Clause 11. The method according to clause 10, wherein generating the data object further includes generating the data object to include an identifier of an individual that provided the at least one answer to the at least one question.

Clause 12. The method according to at least one of clauses 10-11, wherein generating the data object further includes generating the data object to include a field providing a mechanism that allows a user to respond to the at least one question in the data object.

Clause 13. The method according to at least one of clauses 10-12, further comprising linking at least one permission to the data object, the at least one permission used to determine which users gain access to, receive or modify the data object.

Clause 14. The method according to at least one of clauses 10-13, wherein generating the data object further includes generating the data object to include an identifier of an individual that posed the at least one question.

Clause 15. An apparatus for generating a data object that includes content from a communication session, the apparatus comprising: means for receiving a data object that includes a question associated with communication session data linked to a live or recorded communication session, the question posed by a participant of the live or recorded communication session or generated by a computerized agent from analysis of one or more inquires recognized from the communication session data; means for identifying a first context of the question included in the data object; means for identifying a second context of data of a computerized platform; means for comparing the first context and the second context; means for determining the first context and the second context are related contextually based on the comparing of the first context and the second context; and means for communicating the data object to the computerized platform.

Clause 16. The apparatus according to clause 15, wherein identifying the first context comprises analyzing the question included in the data object to identify a subject matter of the question and identifying the second context comprises analyzing the data of the computerized platform to determine a subject matter of the data of the computerized platform.

Clause 17. The apparatus according to at least one of clauses 15-16, wherein determining the first context and the second context are contextually related comprises determining that the subject matter of the question and the subject matter of the data of the computer platform are related contextually.

Clause 18. The apparatus according to at least one of clauses 15-17, wherein the computerized platform is a computer application to display the data object including the at least one question.

Clause 19. The apparatus according to at least one of clauses 15-18, further comprising means for assigning at least one permission to the data object in advance of communicating the data object to the computerized platform.

Clause 20. The apparatus according to clause 19, wherein the at least one permission is used to determine which users may gain access to, receive or modify the data object.

Clause 21. A computing device, comprising: a processor; a computer-readable storage medium in communication with the processor, the computer-readable storage medium having computer-executable instructions stored thereupon which, when executed by the processor, cause the processor to: parse, by the computing device, communication session data to identify and extract a question posed during a communication session associated with the communication session data; generate, by the computing device, a data object that includes a plurality of compiled questions, wherein the plurality of compiled questions comprises the question extracted from the communication session data; identify, by the computing device, a first context of the question; identify, by the computing device, a second context associated with activity data; determine that the first context of the question and the second context associated with the activity data have a threshold level of relevancy; and communicate the data object comprising at least the question identified and extracted from the communication session data to a client computing device in response to determining that the first context of the question and the second context associated with the activity data have the threshold level of relevancy, the data object to cause display of the question.

Clause 22. The computing device according to clause 21, wherein identifying the first context comprises analyzing the question included in the data object to identify a subject matter of the question and identifying the second context comprises analyzing the activity data of a computerized platform to determine the subject matter of the activity data.

Clause 23. The computing device according to clause 22, wherein determining the first context and the second context are contextually related comprises determining that the subject matter of the question and the subject matter of the activity data of the computerized platform are related contextually.

Clause 24. The computing device according to at least one of clauses 22-23, wherein the data object is to cause the display of the question in association with a computer application.

Clause 25. The computing device according to clause 24, wherein the computer application is a word processing application, spreadsheet application, web browser application, or collaborative meeting application.

Clause 26. The computing device according to at least one of clauses 21-25, further comprising assigning at least one permission to the data object in advance of communicating the data object to the client computing device.

Clause 27. The computing device according to clause 26, wherein the at least one permission is used to determine which users gain access to, receive or modify the data object.

Clause 28. The computing device according to at least one of clauses 21-27, further comprising receiving an updated data object derived from the data object communicated to the client computing device.

Clause 29. The computing device according to clause 28, wherein the updated data object includes data representing an answer to the at least one question.

Clause 30. A method for generating a data object that includes content from a communication session, the method comprising: analyzing and parsing, by a computer implemented agent, communication session data to identify and extract at least one question posed and at least one answer to the at least one question posed during a communication session associated with the communication session data; generating, by the computer implemented agent, a data object that includes the at least one question and the at least one answer that occurred during the communication session, the at least one question and the at least one answer identified and extracted from the communication session data; and communicating the data object to a computing device, the computing device to store the data object for dissemination and display by at least one computer implemented platform based on at least a context of the at least one question included in the data object and a context of data associated with the at least one computer implemented platform.

Clause 31. The method according to clause 30, wherein generating the data object further includes generating the data object to include an identifier of an individual that provided the at least one answer to the at least one question.

Clause 32. The method according to at least one of clauses 30-31, wherein generating the data object further includes generating the data object to include a field providing a mechanism that allows a user to respond to the at least one question in the data object.

Clause 33. The method according to at least one of clauses 30-32, further comprising linking at least one permission to the data object, the at least one permission used to determine which users gain access to, receive or modify the data object.

Clause 34. The method according to at least one of clauses 30-33, wherein generating the data object further includes generating the data object to include an identifier of an individual that posed the at least one question.

Clause 35. An apparatus for generating a data object that includes content from a communication session, the apparatus comprising: means for receiving a data object that includes a question identified and extracted from parsing communication session data linked to a live or recorded communication session, the question posed by a participant of the live or recorded communication session or generated by a computerized agent from analysis of one or more inquires recognized from the communication session data; means for identifying a first context of the question included in the data object; means for identifying a second context associated with activity data; means for determining that the first context of the question and the second context associated with the activity data are related using at least one relevancy criterion; and means for communicating the data object comprising the question to a client computing device in response to determining that the first context of the question and the second context associated with the activity data are related, the data object to cause display of the question.

Clause 36. The apparatus according to clause 35, wherein identifying the first context comprises analyzing the question included in the data object to identify a subject matter of the question and identifying the second context comprises analyzing the activity data to determine a subject matter of the activity data.

Clause 37. The apparatus according to at least one of clauses 35-36, wherein determining the first context and the second context are contextually related comprises determining that the subject matter of the question and the subject matter of the activity data are related contextually.

Clause 38. The apparatus according to at least one of clauses 35-37, wherein the data object is to cause the display of the question in association with a computer application.

Clause 39. The apparatus according to at least one of clauses 35-38, further comprising means for assigning at least one permission to the data object in advance of communicating the data object to the client computing device.

Clause 40. The apparatus according to clause 39, wherein the at least one permission is used to determine which users may gain access to, receive or modify the data object.

Although the techniques have been described in language specific to structural features and/or methodological acts, it is to be understood that the appended claims are not necessarily limited to the features or acts described. Rather, the features and acts are described as example implementations of such techniques.

The technologies described herein address the technical need to provide an improved question and answer recognition and dissemination of questions and answers associated with communication sessions. Specifically, at least some of the described implementations provide technologies to generate data objects that include questions and answers observed during communication sessions. The generated data objects may be retained and associated with live and recorded communication sessions. The data objects may be communicated to users for review and further input. The data objects may advantageously be displayed and interacted with using different applications, such as word processing applications, spreadsheet applications, chat applications, and the like.

It should be appreciated that the above-described subject matter may be implemented as a computer-controlled apparatus, a computer process, a computing system, or as an article of manufacture such as a computer-readable storage medium. Among many other benefits, the techniques disclosed herein improve efficiencies with respect to a wide range of computing resources. For instance, human interaction with devices and systems may be improved as a result of the use of the techniques disclosed herein enable users and individuals to remotely manipulate rendered streams within a graphical environment associated with a communication session to better reflect their interactions in the communication session. Other technical effects other than those mentioned herein can also be realized from implementations of the technologies disclosed herein.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

1. A computing device, comprising:
a processor;
a computer-readable storage medium in communication with the processor, the computer-readable storage medium having computer-executable instructions stored thereupon which, when executed by the processor, cause the processor to:
parse, by the computing device, communication session data to identify and extract a question posed during a communication session associated with the communication session data;
generate, by the computing device, a data object that includes a plurality of compiled questions, wherein the plurality of compiled questions comprises the question extracted from the communication session data;
identify, by the computing device, a first context of the question;
identify, by the computing device, a second context associated with activity data;
determine that the first context of the question and the second context associated with the activity data have a threshold level of relevancy; and
communicate the data object comprising at least the question identified and extracted from the communication session data to a client computing device in response to determining that the first context of the question and the second context associated with the activity data have the threshold level of relevancy, the data object to cause display of the question.

2. The computing device according to claim 1, wherein identifying the first context comprises analyzing the question included in the data object to identify a subject matter of the question and identifying the second context comprises analyzing the activity data of a computerized platform associated with the client computing device to determine the subject matter of the activity data.

3. The computing device according to claim 2, wherein determining the first context and the second context are contextually related comprises determining that the subject matter of the question and the subject matter of the activity data of the computerized platform are related contextually.

4. The computing device according to claim 1, wherein the data object is to cause the display of the question in association with a computer application.

5. The computing device according to claim 4, wherein the computer application is a word processing application, spreadsheet application, web browser application, or collaborative meeting application.

6. The computing device according to claim 1, further comprising assigning at least one permission to the data object in advance of communicating the data object to the client computing device.

7. The computing device according to claim 6, wherein the at least one permission is used to determine which users gain access to, receive or modify the data object.

8. The computing device according to claim 1, further comprising receiving an updated data object derived from the data object communicated to the client computing device.

9. The computing device according to claim 8, wherein the updated data object includes data representing an answer to the at least one question.

10. A method for generating a data object that includes content from a communication session, the method comprising:
analyzing and parsing, by a computer implemented agent, communication session data to identify and extract at least one question posed and at least one answer to the at least one question posed during a communication session associated with the communication session data;
generating, by the computer implemented agent, a data object that includes the at least one question and the at least one answer that occurred during the communication session, the at least one question and the at least one answer identified and extracted from the communication session data; and
communicating the data object to a computing device, the computing device to store the data object for dissemination and display by at least one client computing device based on at least a context of the at least one question included in the data object and a context of data associated with the at least one client computing device.

11. The method according to claim 10, wherein generating the data object further includes generating the data object to include an identifier of an individual that provided the at least one answer to the at least one question.

12. The method according to claim 10, wherein generating the data object further includes generating the data object to include a field providing a mechanism that allows a user to respond to the at least one question in the data object.

13. The method according to claim 10, further comprising linking at least one permission to the data object, the at least one permission used to determine which users gain access to, receive or modify the data object.

14. The method according to claim 10, wherein generating the data object further includes generating the data object to include an identifier of an individual that posed the at least one question.

15. An apparatus for generating a data object that includes content from a communication session, the apparatus comprising:
means for receiving a data object that includes a question identified and extracted from parsing communication session data linked to a live or recorded communication session, the question posed by a participant of the live or recorded communication session or generated by a computerized agent from analysis of one or more inquires recognized from the communication session data;
means for identifying a first context of the question included in the data object;
means for identifying a second context associated with activity data;
means for determining that the first context of the question and the second context associated with the activity data are related using at least one relevancy criterion; and
means for communicating the data object comprising the question to a client computing device in response to determining that the first context of the question and the second context associated with the activity data are related, the data object to cause display of the question.

16. The apparatus according to claim 15, wherein identifying the first context comprises analyzing the question included in the data object to identify a subject matter of the question and identifying the second context comprises analyzing the activity data to determine a subject matter of the activity data.

17. The apparatus according to claim 16, wherein determining the first context and the second context are contextually related comprises determining that the subject matter of the question and the subject matter of the activity data are related contextually.

18. The apparatus according to claim 15, wherein the data object is to cause the display of the question in association with a computer application.

19. The apparatus according to claim 15, further comprising means for assigning at least one permission to the data object in advance of communicating the data object to the client computing device.

20. The apparatus according to claim 19, wherein the at least one permission is used to determine which users may gain access to, receive or modify the data object.
